(19) United States
(12) Patent Application Publication
(10) Pub. No.: US 2022/0295694 A1
(43) Pub. Date: Sep. 22, 2022

(54) Foliar Spraying With Water Infused With Ammonia

(71) Applicant: CO2Gro INC., Toronto (CA)

(72) Inventors: John H. Archibald, Grimsby (CA); Matthew Julius, Sauk Rapids, MN (US)

(21) Appl. No.: 17/638,956

(22) PCT Filed: Aug. 27, 2019
(86) PCT No.: PCT/CA2019/051172

§ 371 Date: Feb. 28, 2022

(51) Int. Cl. A01C 23/04; C05C 3/00

(52) U.S. Cl. CPC A01C 23/042; C05C 3/00

(57) ABSTRACT

Plants use nitrogen as one of the essential elements required in their metabolism. Although the atmosphere is composed predominantly of molecular nitrogen, plants cannot break these nitrogen molecules into the elemental nitrogen required by the plants. In nature, bacteria “fix” the nitrogen in the atmosphere by using it to produce ammonia, which can be metabolized by plants. Nitrogen can also be introduced to the plants artificially, using natural or artificial fertilizer or even by direct injection of nitrogen into the soil. In all these cases, nitrogen is delivered to the plant via its roots. The present invention delivers instead ammonia to the leaves of the plants through foliar spraying by infusing water used in foliar spraying with ammonia. This is more efficient than delivery through roots of the plant, and greatly reduces the problem of fertilizer run-off.

### RELATED APPLICATIONS

This application is a national United States filing under 35 USC 371, claiming priority from PCT patent application PCT/CA2019/051172, filed on Aug. 27, 2019.

### FIELD OF INVENTION

This invention relates to agriculture, and more particularly to foliar spraying of plants.

### BACKGROUND

Plants use nitrogen as one of the essential elements required in normal metabolism. Unfortunately, although the atmosphere is composed predominantly of molecular nitrogen, plants cannot break these nitrogen molecules into the elemental nitrogen required by the plants. In nature, microorganisms, including some bacteria, “fix” the nitrogen in the atmosphere by using it to produce ammonia. The ammonia produced by these microorganisms, called diazotrophs, can then be taken up by and metabolized by plants. The efficiency of this uptake depends on the degree of symbiosis between the diazotrophs and the particular plant group in question.

Nitrogen can also be introduced to plants artificially, using natural or artificial fertilizer spread on the soil in which the plants grow. In the case of artificial fertilizer, ammonia within fertilizer pellets gradually dissolves into the soil. Ammonia can even be introduced to plants by direct injection of ammonia into the soil. In all these cases, whether “fixing” by bacteria, use of fertilizer, or direct injection into the soil, ammonia is delivered to the plant via its roots.

Although useful, there are some drawbacks with the artificial means of introducing nitrogen to plants. The efficiency of these processes is hampered by the fact that the plants do not access all the nitrogen in the soil. Inevitably, some fertilizer or injected ammonia will enter soil not reachable by the roots of the plants, and some of the nitrogen may form other compounds in the soil, not all of which are bioavailable. There is also concern with run-off, whereby nitrogen from fertilizer washes into nearby water courses before it can be absorbed by the plants.

Attempts have been made to introduce ammonia atmospherically to plants, but part of the gaseous ammonia can escape from the immediate area of the plants.

It would be desirable to deliver ammonia to plants in a way which reduced run-off, targeted the plants directly rather than the soil surrounding the plants, and reduced gaseous escape of ammonia laden atmosphere.

### SUMMARY

According to one embodiment of the invention, a method of delivering ammonia to a plant is provided. Water is infused with ammonia to create ammonia-infused water. The plant is then foliar sprayed with the ammonia-infused water. In one embodiment, the foliar spraying with ammonia-infused water is carried out over a crop of more than one plant.

The present invention provides substantial benefits in delivery of nitrogen to plants, particular broad-leafed plants and grasses. By using foliar spraying as a delivery method, ammonia is delivered to the plants through stomata on the leaves of the plants. This is more efficient delivery of ammonia than the use of fertilizer, direct injection of ammonia, or adding ammonia to the atmosphere breathed by the plants. This avoids runoff of fertilizer into nearby waterways. Use of foliar spraying to deliver the ammonia is also a more efficient means of delivering ammonia to the plants through the stomata than is increasing the ammonia in the atmosphere breathed by the plants, as the latter technique inevitably results in some waste of ammonia through gaseous escape.

### DETAILED DESCRIPTION OF THE PREFERRED EMBODIMENTS

The method of the invention is usually applied to an entire crop of plants. However, for simplicity the invention will be described with reference to a single plant.

Broadly, ammonia is delivered to a plant by infusing water with ammonia to create ammonia-infused water, and then foliar spraying the plant with the ammonia-infused water.

According to one embodiment of the invention, ammonia is infused into a water supply. The optimal concentration of the ammonia depends on the species of plant being considered, but is typically at concentrations of about 5% to 25% of saturation. The ammonia is infused into the water supply using hollow carbon fibers. Hollow carbon fibers create very small bubbles, or nano bubbles, on the order or 0.2 μm in diameter. The small surface area of the ammonia nano bubbles allows very quick and efficient gas adsorption into the water.

The ammonia-infused water is then applied to a plant through foliar spraying. The foliar spraying is preferably carried out once an hour for 10 or 15 seconds. Higher frequency than this may lead to safety concerns and physiological uptake limits. The foliar spraying is ideally carried out with room temperature water. This keeps the infused ammonia in solution, and because the water is not fully saturated with ammonia it need not be cold. At the same time, as much ammonia as possible should remain in solution, as off-gassing into the atmosphere can lead to smell concerns. Foliar spraying with room temperature water gives the plant the maximum amount of time to take in the ammonia without inadvertently releasing it into the atmosphere.

The plant is preferably of the class of broad-leafed plants or grasses, so that the ammonia-infused water is able to cover a large number of stomata. A film of water covers the entire (or most of) the leaves of the plant, and at the concentrations given above ammonia is accessible to most or all stomata on the leaves.

In general, foliar spraying with the ammonia-infused water should occur during daylight, when the stomata are open and transpiration is occurring, although foliar spraying with the ammonia-infused water can be done at night albeit with less efficacy.

The invention has been described using hollow carbon fibers to infuse the ammonia in the water. Alternatively, other gas infusion methods can be used, such as the use of air stones. But depending on the method of gas infusion used, large quantities of ammonia can be lost to the atmosphere as large bubbles of gas rise through the water before being adsorbed. The use of hollow carbon fibers and the resulting nano bubbles increases the amount of ammonia adsorbed by the water.

The invention as been described as applying ammonia-infused water to a single plant through foliar spraying. Alternatively, and more usually, foliar spraying with ammonia-infused water is applied to multiple plants.

The embodiments presented are exemplary only and persons skilled in the art would appreciate that variations to the embodiments described above may be made without departing from the spirit of the invention. The scope of the invention is solely defined by the appended claims.

I/We claim:

1. A method of delivering ammonia to a plant comprising:
infusing water with ammonia to create ammonia-infused water; and
foliar spraying the plant with the ammonia-infused water.

2. The method of claim 1 wherein infusing water with ammonia to create ammonia-infused water comprises using hollow carbon fibers to infuse the ammonia in water.

3. The method of claim 2 wherein the hollow carbon fibers create ammonia bubbles of about 0.2 μm in diameter in the water.

4. The method of claim 1 wherein foliar spraying the plant with ammonia-infused water comprises foliar spraying for about 10 to 15 seconds more than once at a frequency of about once per hour.

5. The method of claim 1 wherein the plant is a broad-leafed plant or grass.

6. The method of claim 1 wherein the ammonia-infused water has a concentration of about 5% to 25% ammonia.

7. The method of claim 1 further comprising foliar spraying additional plants with the ammonia-infused water so as to foliar spray a crop of plants.

8. The method of claim 7 wherein infusing water with ammonia to create ammonia-infused water comprises using hollow carbon fibers to infuse the ammonia in water.

9. The method of claim 8 wherein the hollow carbon fibers create ammonia bubbles of about 0.2 μm in diameter in the water.

10. The method of claim 7 wherein foliar spraying the plants of the crop with ammonia-infused water comprises foliar spraying for about 10 to 15 seconds more than once at a frequency of about once per hour.

11. The method of claim 7 wherein the plants of the crop are broad-leafed plants or grasses.

12. The method of claim 7 wherein the ammonia-infused water has a concentration of about 5% to 25% ammonia.
